(19) United States
(12) Patent Application Publication
(10) Pub. No.: US 2012/0229463 A1
(43) Pub. Date: Sep. 13, 2012

(54) 3D IMAGE VISUAL EFFECT PROCESSING METHOD

(75) Inventors: YU-CHOU YEH, TAOYUAN COUNTY (TW); LIANG-KAO CHANG, TAOYUAN COUNTY (TW)

(73) Assignee: J TOUCH CORPORATION, TAOYUAN COUNTY (TW)

(21) Appl. No.: 13/095,112

(22) Filed: Apr. 27, 2011

(30) Foreign Application Priority Data
Mar. 11, 2011 (TW) 100108355

(51) Int. Cl. G06T 15/40; G06T 15/00

(52) U.S. Cl. 345/422; 345/419

(57) ABSTRACT

The present invention discloses a 3D image visual effect processing method comprising the steps of providing a 3D image, and the 3D image being composed of a plurality of objects, and each of the objects having object coordinates; providing a cursor, and the cursor having cursor coordinates; determining whether or not the cursor coordinates are coincident with the object coordinates of one of the objects; changing a depth coordinate parameter corresponding to the object coordinates of the plurality of object, if the cursor coordinates are coincident with the object coordinates of one of the objects; and redrawing an image of the object matched with the cursor coordinates. Therefore, the invention can highlight the 3D image of an image corresponding to the cursor to enhance the visual effect and interaction.

### CROSS-REFERENCE TO RELATED APPLICATIONS

This non-provisional application claims priority under 35 U.S.C. §119(a) on Patent Application No(s). 100108355 filed in Taiwan, R.O.C. on Mar. 11, 2011, the entire contents of which are hereby incorporated by reference.

### BACKGROUND OF THE INVENTION

1. Field of the Invention

The present invention relates to an image processing method, and more particularly to a 3D image visual effect processing method.

2. Description of the Prior Art

In past two decades, computer graphics has become the most important data displaying method of man-machine interactions and it has been used extensively in different applications such as three dimensional (3D) computer graphics. Multimedia and virtual-reality products become increasingly more popular, not only achieving a major breakthrough of man-machine interactions, but also playing an important role in recreational applications. Most of the aforementioned applications adopt a low-cost real-time 3-D computer graphics technology, and the 2-D computer graphics technology is commonly used in a general description to represent data and contents, particularly in interactive applications. For 3-D computer graphics, the 3D computer graphics has become a well-developed branch of computer graphics, whose 3D models and various image processing technologies are usually used for generating images with 3D spatial reality.

The development of 3D computer graphics is mainly divided into three basic stages by their order:

1. Modeling: A modeling stage can be described as a process of “confirming the shape of objects required and used in the next scene”, and there are various different modeling techniques such as constructive solid geometry (CSG) modeling, non-uniform rational B-spline (NURBS) modeling, polygon modeling or subdivision surface. In addition, the modeling stage can include editing object surface or material properties, and adding texture, bump mapping and other characteristics.

2: Layout & Animation: Layout involves arranging the light of a virtual object in a scene, and the position and size of a camera or other entities that will be used for producing a static screen or an animation. Animation is produced by technologies such as key framing to create complicated motion relations in a scene.

3: Rendering: Rendering is the final stage of creating an actual 2D image or animation from a preparatory scene and analogous to a layout photo or a produced scene in the real world.

In the prior art, the 3D objects drawn for interactive multimedia games or application programs usually cannot change the cursor coordinate position to produce a corresponding change to highlight its visual effect instantly when a user operates the mouse, touchpad or touch panel, thus failing to provide the user sufficient interactions with the scene.

A conventional 2D-to-3D conversion technology generally selects a main object from a 2D image, sets the main object as foreground and the remaining objects as background, and assigns different depths of field to the objects to produce a 3D image. However, when a user operates the mouse which generally has the same depth of field with the display screen, and the position of operating the mouse is situated at where the vision stays. If the depth of field of the mouse is different from the depth of field of the object, spatial vision will be disoriented.

### SUMMARY OF THE INVENTION

Therefore, it is a primary objective of the present invention to provide a 3D image visual effect processing method capable of highlighting the 3D image of an object according to a cursor coordinate position to enhance human-computer interaction.

To achieve the foregoing objective, the present invention provides a 3D image visual effect processing method comprising the following steps:

Provide a 3D image, wherein the 3D image is comprised of a plurality of objects, and each of the objects has object coordinates. Provide a cursor, wherein the cursor has cursor coordinates. Determine whether or not the cursor coordinates are coincident with the object coordinates of one of the objects. Change a depth coordinate parameter corresponding to the object coordinates of the plurality of object, if the cursor coordinates are coincident with the object coordinates of one of the objects. Redraw an image of the object matched with the cursor coordinates.

Determine whether or not the cursor coordinates are coincident with the object coordinates of one of the objects again, if the cursor coordinates are changed.

Wherein, the objects have coordinates corresponding to local coordinates, world coordinates, view coordinates or projection coordinates.

Wherein, the cursor coordinates are generated by a mouse, a touchpad or a touch panel.

Wherein, the 3D image is generated by a computer graphics procedure sequentially comprising the stages of modeling, layout & animation and rendering.

Wherein, the depth coordinates of the object coordinates of the plurality of objects are determined by a Z buffer algorithm, painter's algorithm (or depth-sort algorithm), plane normal determination algorithm, surface normal determination algorithm, or maximum/minimum algorithm.

### BRIEF DESCRIPTION OF THE DRAWINGS

FIG. 1A is a flow chart of a 3D image visual effect processing method in accordance with a preferred embodiment of the present invention;

FIG. 1B is a schematic view of a 3D image generated by a 3D image visual effect processing method in accordance with a preferred embodiment of the present invention;

FIG. 2 is a flow chart of drawing a 3D image by a 3D image visual effect processing method in accordance with the present invention;

FIG. 3A is a schematic view of using a union operator for modeling by a 3D image visual effect processing method in accordance with the present invention;

FIG. 3B is a schematic view of using an intersect operator for modeling by a 3D image visual effect processing method in accordance with the present invention;

FIG. 3C is a schematic view of using a complement operator for modeling by a 3D image visual effect processing method in accordance with the present invention;

FIG. 4A is a schematic view of using a NURBS curve for modeling by a 3D image visual effect processing method in accordance with the present invention; FIG. 4B is a schematic view of using a NURBS surface for modeling by a 3D image visual effect processing method in accordance with the present invention;

FIG. 5 is a schematic view of using polygon mesh for modeling by a 3D image visual effect processing method in accordance with the present invention;

FIG. 6A is a first schematic view of using a subdivision surface for modeling by a 3D image visual effect processing method in accordance with the present invention;

FIG. 6B is a second schematic view of using a subdivision surface for modeling by a 3D image visual effect processing method in accordance with the present invention;

FIG. 6C is a third schematic view of using a subdivision surface for modeling by a 3D image visual effect processing method in accordance with the present invention;

FIG. 6D is a fourth schematic view of using a subdivision surface for modeling by a 3D image visual effect processing method in accordance with the present invention;

FIG. 6E is a fifth schematic view of using a subdivision surface for modeling by a 3D image visual effect processing method in accordance with the present invention;

FIG. 7 is a schematic view of a standard graphics rendering pipeline used in a 3D image visual effect processing method in accordance with the present invention;

FIG. 8 is a first schematic view of an image display by a 3D image visual effect processing method in accordance with a preferred embodiment of the present invention;

FIG. 9 is a second schematic view of an image display by a 3D image visual effect processing method in accordance with a preferred embodiment of the present invention;

FIG. 10 is a third schematic view of an image display by a 3D image visual effect processing method in accordance with a preferred embodiment of the present invention;

FIG. 11A is a fourth schematic view of an image display by a 3D image visual effect processing method in accordance with a preferred embodiment of the present invention;

FIG. 11B is a fifth schematic view of an image display by a 3D image visual effect processing method in accordance with a preferred embodiment of the present invention;

FIG. 12A is a first schematic view of using a Z-buffer algorithm for drawing an object by a 3D image visual effect processing method in accordance with the present invention;

FIG. 12B is a second schematic view of using a Z-buffer algorithm for drawing an object by a 3D image visual effect processing method in accordance with the present invention;

FIG. 13A is a first schematic view of using a painter's algorithm (or depth-sort algorithm) for drawing an object by a 3D image visual effect processing method in accordance with the present invention;

FIG. 13B is a second schematic view of using a painter's algorithm (or depth-sort algorithm) for drawing an object by a 3D image visual effect processing method in accordance with the present invention;

FIG. 13C is a third schematic view of using a painter's algorithm (or depth-sort algorithm) for drawing an object by a 3D image visual effect processing method in accordance with the present invention;

FIG. 14 is a schematic view of using a plane normal determination algorithm for drawing an object by a 3D image visual effect processing method in accordance with the present invention; and

FIG. 15 is a schematic view of using a maximum/minimum algorithm for drawing an object by a 3D image visual effect processing method in accordance with the present invention.

### DETAILED DESCRIPTION OF THE PREFERRED EMBODIMENTS

To make it easier for our examiner to understand the technical contents of the present invention, preferred embodiments together with related drawings are used for the detailed description of the present invention as follows.

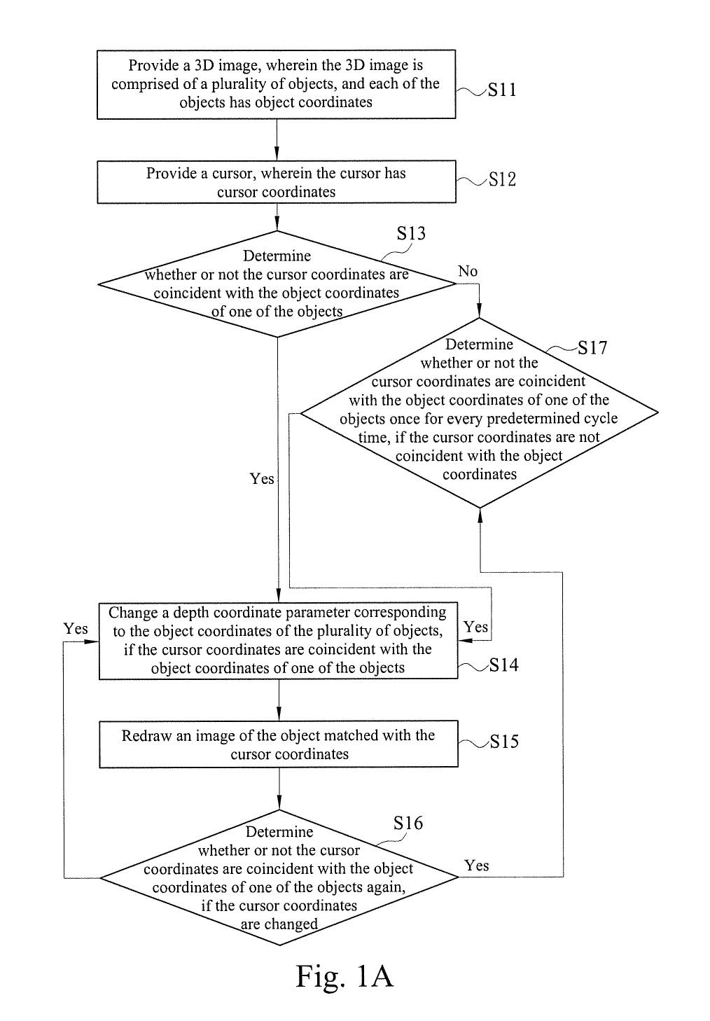

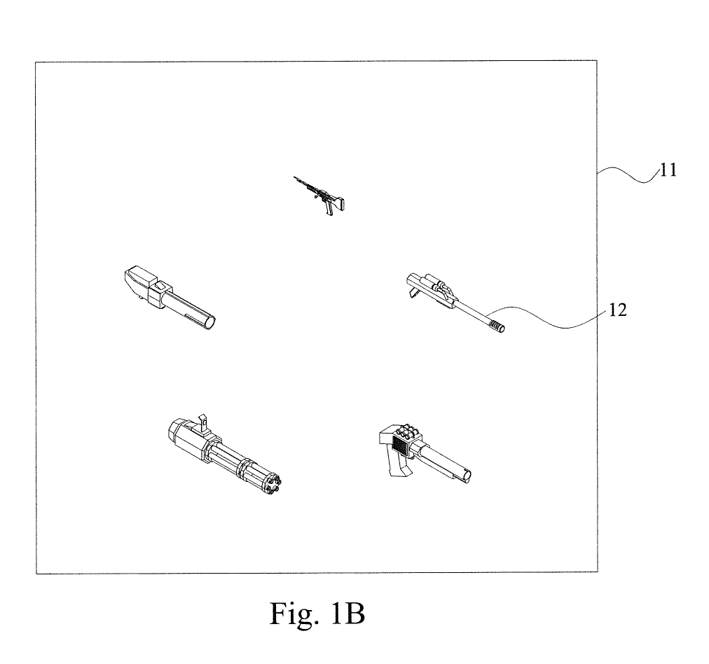

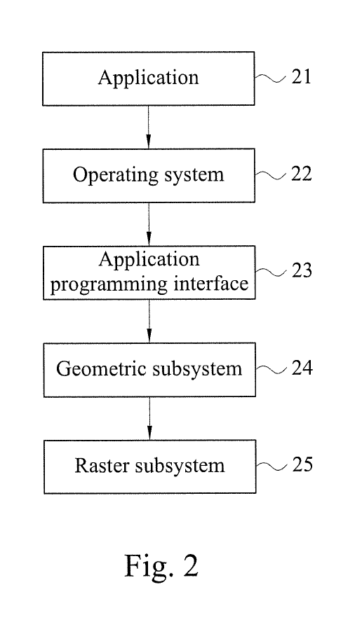

With reference to FIGS. 1A, 1B and 2 for a flow chart and a schematic view of a 3D image visual effect processing method in accordance with a preferred embodiment of the present invention and a flow chart of drawing a 3D image by the 3D image visual effect processing method respectively, the 3D image 11 is comprised of a plurality of objects 12 and generated sequentially by an application 21, an operating system 22, an application programming interface (API) 23, a geometric subsystem 24 and a raster subsystem 25. The 3D image visual effect processing method comprises the following steps:

S11: Provide a 3D image, wherein the 3D image is comprised of a plurality of objects, and each of the objects has object coordinates.

S12: Provide a cursor, wherein the cursor has cursor coordinates.

S13: Determine whether or not the cursor coordinates are coincident with the object coordinates of one of the objects.

S14: Change a depth coordinate parameter corresponding to the object coordinates of the plurality of objects, if the cursor coordinates are coincident with the object coordinates of one of the objects.

S15: Redraw an image of the object matched with the cursor coordinates.

S16: Determine whether or not the cursor coordinates are coincident with the object coordinates of one of the objects again, if the cursor coordinates are changed.

S17: Determine whether or not the cursor coordinates are coincident with the object coordinates of one of the objects once for every predetermined cycle time, if the cursor coordinates are not coincident with the object coordinates.

Wherein, the cursor coordinates are generated by a mouse, a touchpad, a touch panel, or any human-computer interaction between a user and an electronic device.

Wherein, the 3D image 11 is drawn by 3D computer graphics. The 3D image is generated by a computer graphics procedure comprising the sequential stages of: modeling, layout & animation and rendering.

Wherein, the modeling stage is mainly divided into the following types:

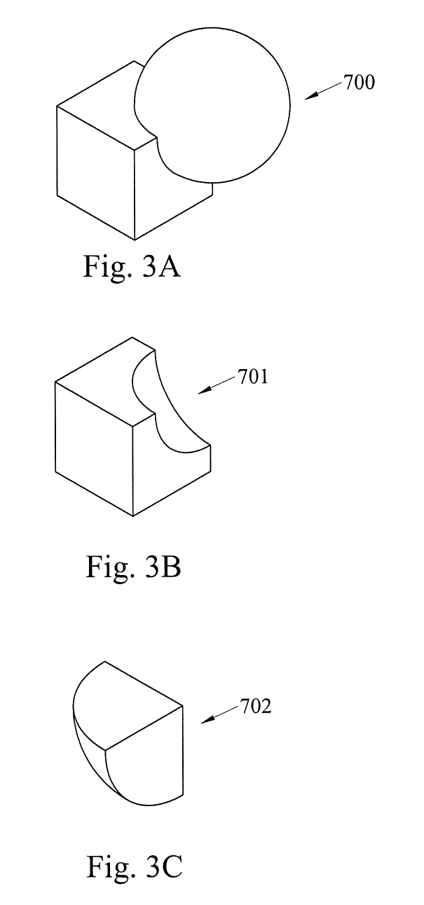

1: Constructive Solid Geometry (CSG): In CSG, a logical operator is used for combining different objects (such as a cube, a cylinder, a prism, a pyramid, a sphere, and a cone) into complicated surfaces by union, intersect and complement to form a union geometric FIG. 700, an intersect geometric FIG. 701 and a complement geometric FIG. 702, and these geometric figures can be used to create complicated models or surfaces as shown in FIGS. 3A, 3B and 3C.

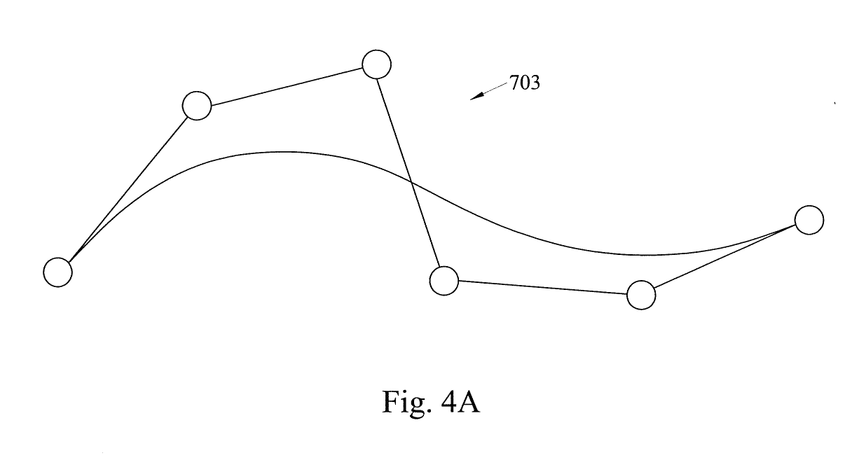

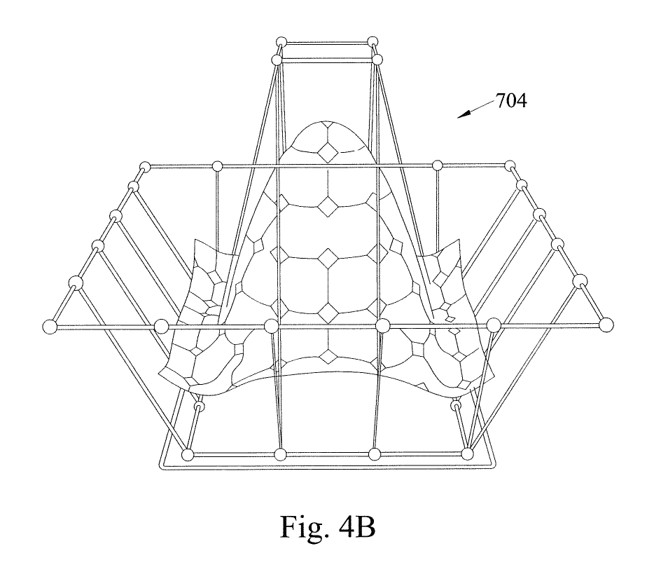

2: Non-Uniform Rational B-Spline (NURBS): The NURBS can be used for generating and representing a curve and a surface, and a NURBS curve 703 is determined by an order, a group of weighted control points and a knot vector. Wherein, NURBS is the broad concept of both B-spline and Bézier curves and surfaces. With the estimation of s and t parameters of a NURBS surface 704, this surface can be represented in space coordinates as shown in FIGS. 4A and 4B.

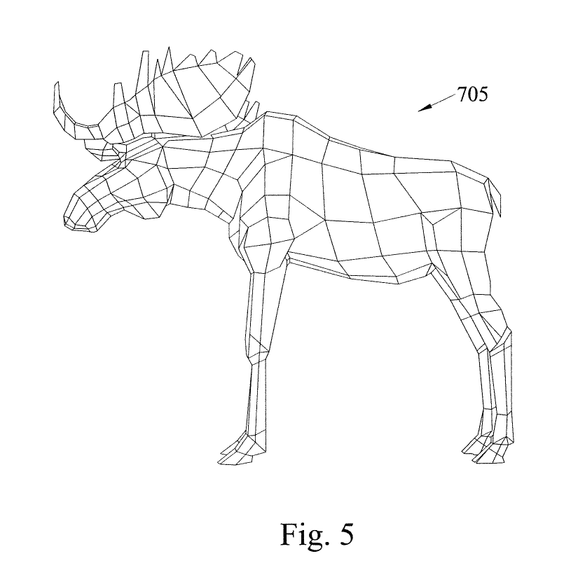

3: Polygon Modeling: Polygon modeling is an object modeling method that uses polygon meshes for the representation or for approaching the surface of objects. In general, the mesh is a polygon modeling object 705 composed of triangles, quadrilaterals or other simple convex polygons as shown in FIG. 5.

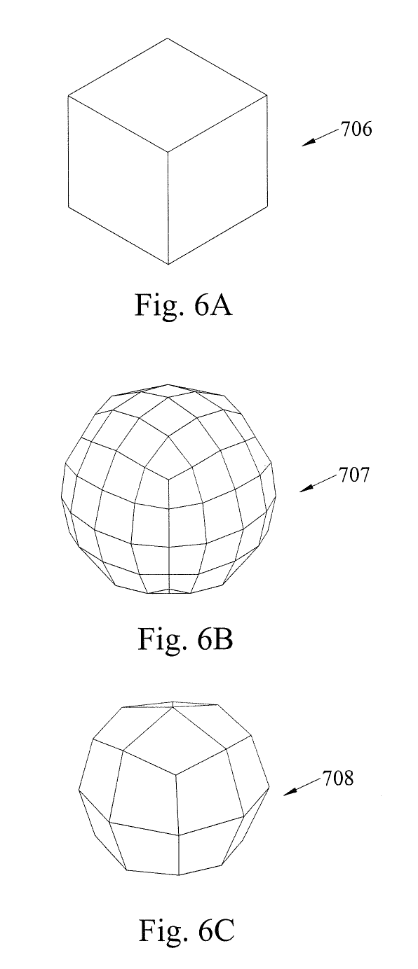

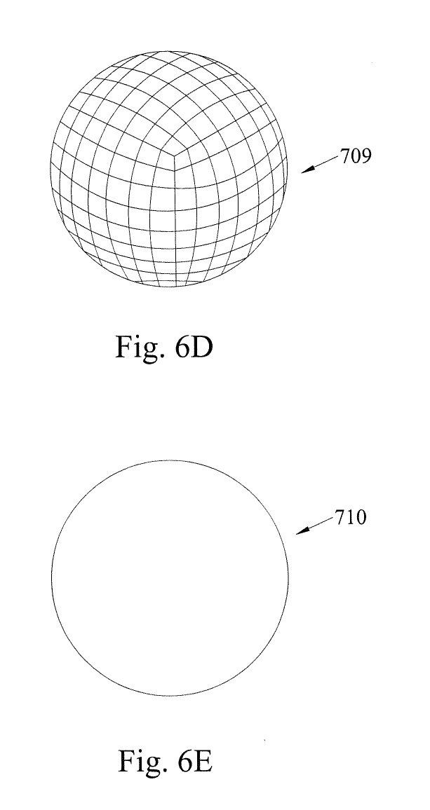

4: Subdivision Surface: Subdivision surface is used in any mesh to create a smooth surface, and polygon meshes processed by subdivision repeatedly can produce a series of meshes approaching to infinite subdivision surface, and each subdivision can produce more polygon elements and smoother meshes. The shape is changed in an order from a cube 706 to a first quasi sphere 707, a second quasi sphere 708, a third quasi sphere 709 and a sphere 710 as shown in FIGS. 6A, 6B, 6C, 6D and 6E respectively.

In the modeling Step, editing object surface or material property, and adding texture, bump mapping and other characteristics can be performed as required.

The layout & animation are used for arranging the light, camera, or other entities of a virtual object in a scene to produce a static screen or an animation. The layout is used for defining the spatial relation of the position and size of an object in scene. The animation is used for the transient description of an object, such as its motion or deformation with time and can be achieved by key framing, inverse kinematics and motion capture.

The rendering is the final stage of creating an actual 2D image or animation from a preparatory scene, and can be divided into a non-real time method or a real time method.

The non-real time method is to achieve a photo realistic effect of a model by light transport, and this method is generally achieved by a ray tracing method or radiosity.

The real time method uses a non photo realistic rendering method to achieve the real-time drawing speed, and the image can be drawn by different methods including flat shading, Phong shading, Gouraud shading, bit map texture, bump mapping, shading, motion blur, or depth of field. If this method is applied for the graphic drawings of interactive multimedia games or simulation programs, both calculation and display must be real-time, and the required speed is approximately equal to 20 to 120 frames per second.

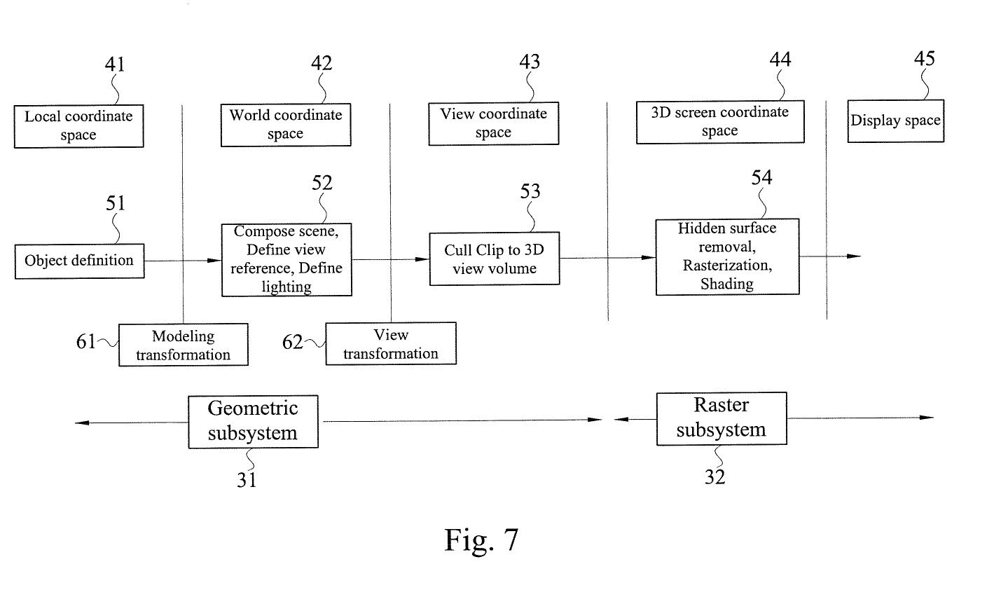

With reference to FIG. 7 for a schematic view of a standard 3D graphics rendering pipeline, a clear description of the 3D graphics drawing method is provided. The rendering pipeline is divided into parts according to different coordinate systems, and mainly includes a geometric subsystem 31 and a raster subsystem 32. The object definition is a definition of an object by 3D model description , and the coordinate system so used refers to its reference point as a local coordinate space 41. When a 3D image is synthesized, each object is read from a database and converted to a unified world coordinate space 42, and performs a scene definition, view reference definition and lighting definition 52 in the world coordinate space 42, and the process of converting the local coordinate space 41 to the world coordinate space 42 is called modeling transformation 61. And then, it is necessary to define a view position. Due to the resolution limitation of a graphic hardware system, it is necessary to convert successive coordinates to a 3D screen space containing X and Y coordinates and a depth coordinate (also known as Z-coordinate) for the hidden surface removal and drawing the object pixel by pixel, and the world coordinate space 42 is converted to a view coordinate space 43 to cull and clip to a 3D view volume 53, and this process is called view transformation 62. And then, the view coordinate space 43 is converted to the 3D screen coordinate space 44 to perform the hidden surface removal, rasterization and shading 54. And then, the frame buffer outputs the final image to the screen and the 3D screen coordinate space is converted to the display space 45. In this preferred embodiment, a micro-processor can be used standalone, or a hardware accelerator apparatus such as a graphic processing unit (GPU) or a 3D graphics accelerator card can be combined together to complete the tasks of the geometric subsystem and the raster subsystem.

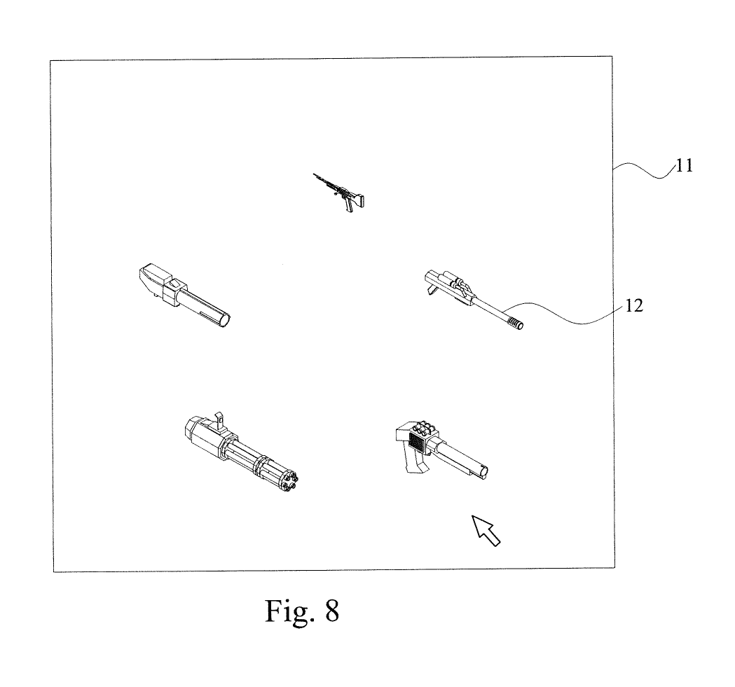

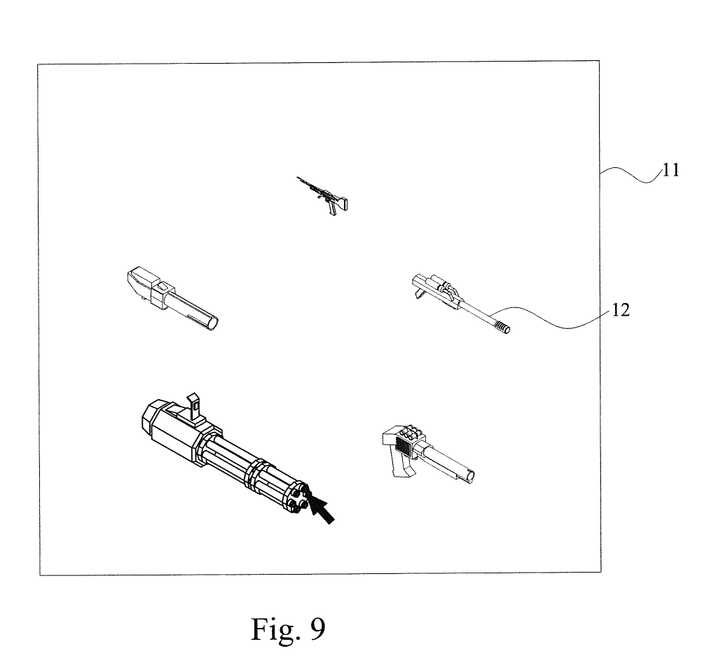

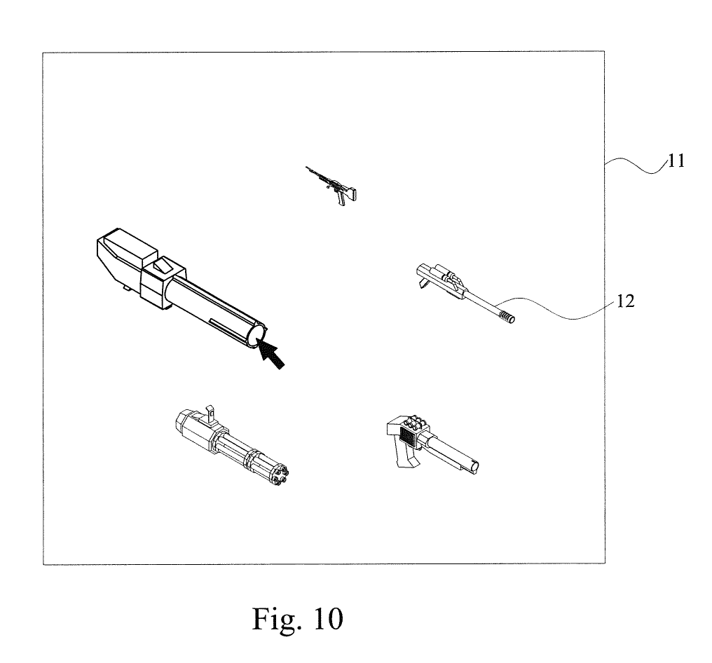

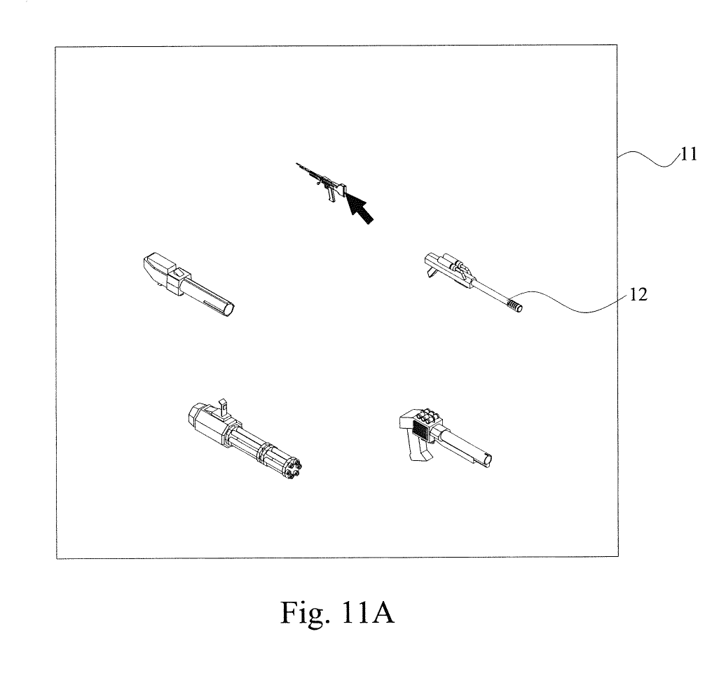

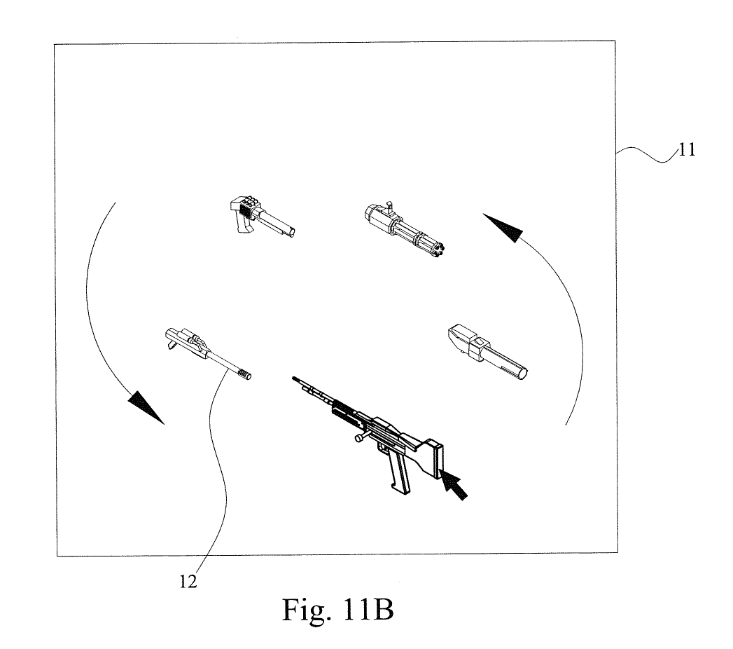

With reference to FIGS. 8, 9, 10, 11A and 11B for first to fifth schematic views of an image display of a 3D image visual effect processing method in accordance with a preferred embodiment of the present invention respectively, if a user operates and moves a mouse, a touchpad, a touch panel or any human-computer interaction tool to move the cursor, and the cursor coordinates are changed, then the method will determine whether or not the cursor coordinates are coincident with the object coordinates of one of the objects 12 again. If they are not coincident, then the original 3D image 11 of the display screen will remain unchanged, and no redrawing will be required. If the cursor coordinates are coincident with the object coordinates of one of the objects 12, then the depth coordinate parameter corresponding to the object coordinates of the plurality of objects will be changed, and the aforementioned 3D graphics rendering pipeline step will be used for redrawing the 3D image 11. If the cursor coordinates are changed and matched with any other object 12, then the originally clicked object 12 restores its original depth coordinate parameter, and the other clicked object 12 will change its depth coordinate parameter. After the whole 3D image 11 is redrawn, the visual 3D effect of the clicked object 12 will be highlighted. Therefore, users can operate a human-computer interaction tool such as a mouse to produce an interactive effect with the 3D image. In addition, if one of the objects 12 matches with the cursor coordinate position and changes its depth coordinate position, the coordinate parameter of the other object 12 can be changed with the cursor coordinate position, so as to further highlight the visual effect and the interactive effect. Wherein, the depth coordinate parameter of the object coordinates of the object can be determined by the following methods:

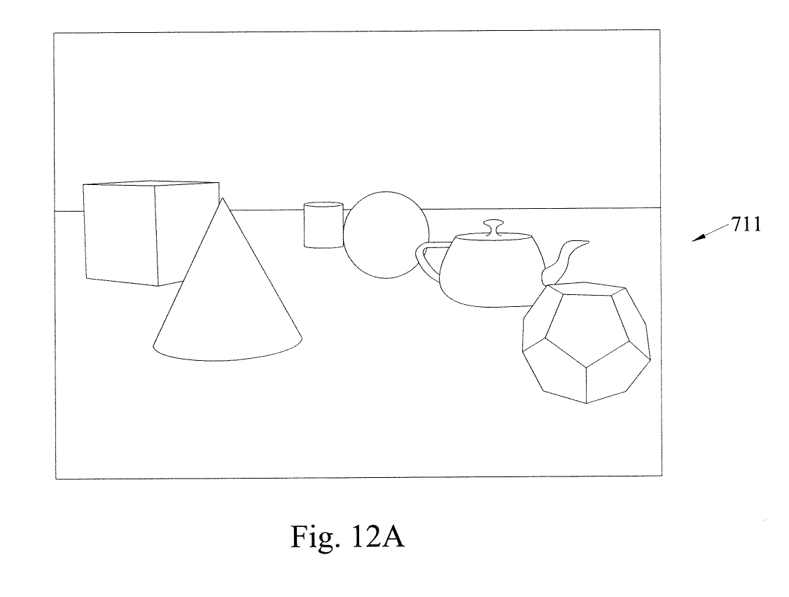

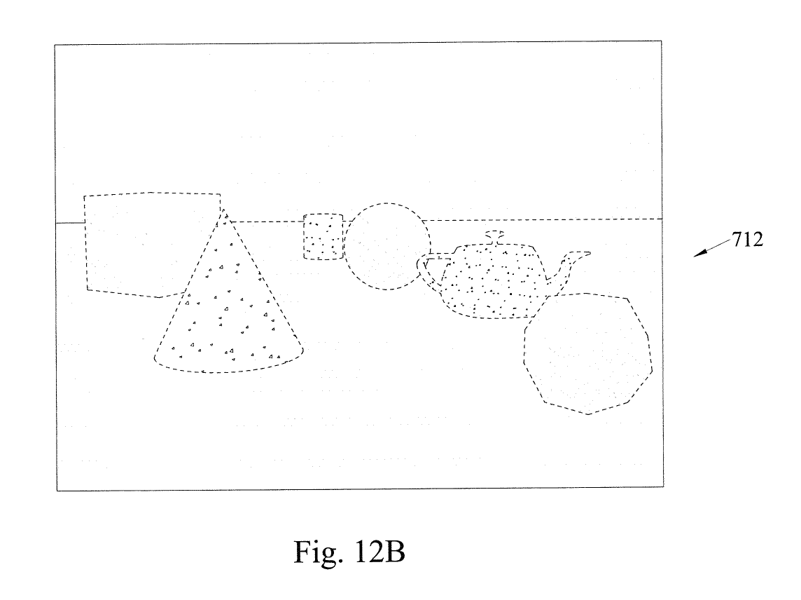

1: Z-buffering (also known as depth buffering): When an object is rendered, the depth (which is the Z-coordinate) of each produced pixel is saved in a buffer, and the buffer is also called a Z-buffer or a depth buffer, and the buffer composes the x-y two-dimensional groups of the depth of each saved pixel of a screen. If another object in the scene is rendered at the same pixel, then the depths of the two will be compared, and the object closer to the observer is kept, and the depth of this object is saved to the depth buffer. Finally, the depth is measured correctly based on the depth buffer, and a nearer object blocks a farther object. This process is called Z culling. In FIGS. 12A and 12B, a Z-buffer 3D image 711 and a Z-buffer schematic image 712 are shown.

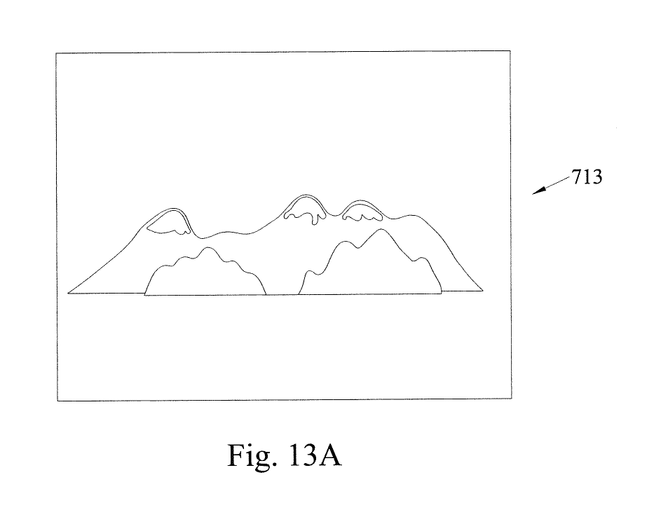

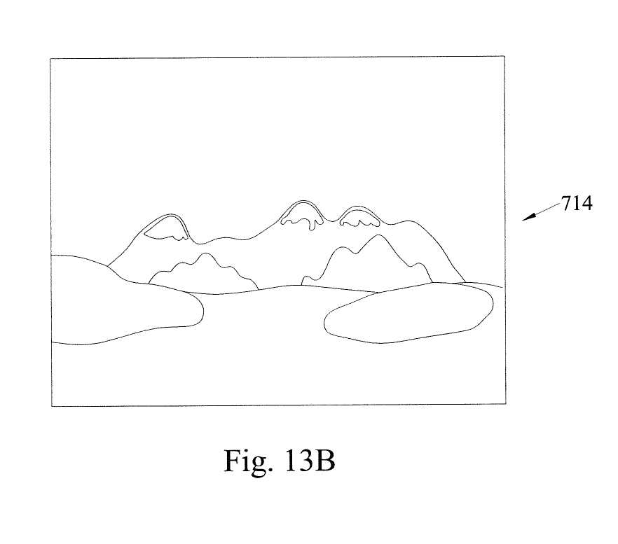

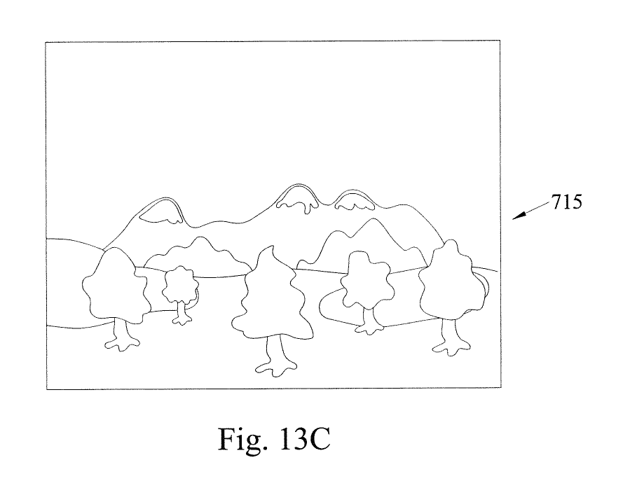

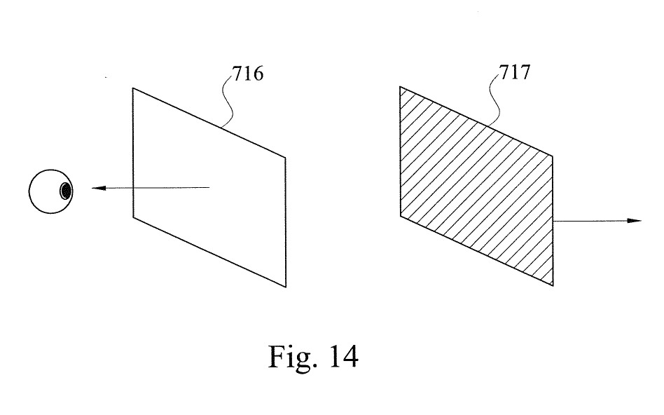

2: Painter's Algorithm (also known as Depth-Sort Algorithm): A farther object is drawn first, and then a nearer object is drawn to cover a portion of the farther object, wherein each object is sorted by its depth, and then drawn according to the sorted sequence, and the produced images are a first painter's depth-sort image 713, a second painter's depth-sort image 714 and a third painter's depth-sort image 715 arranged sequentially (as shown in FIGS. 13A, 13B and 13C respectively).

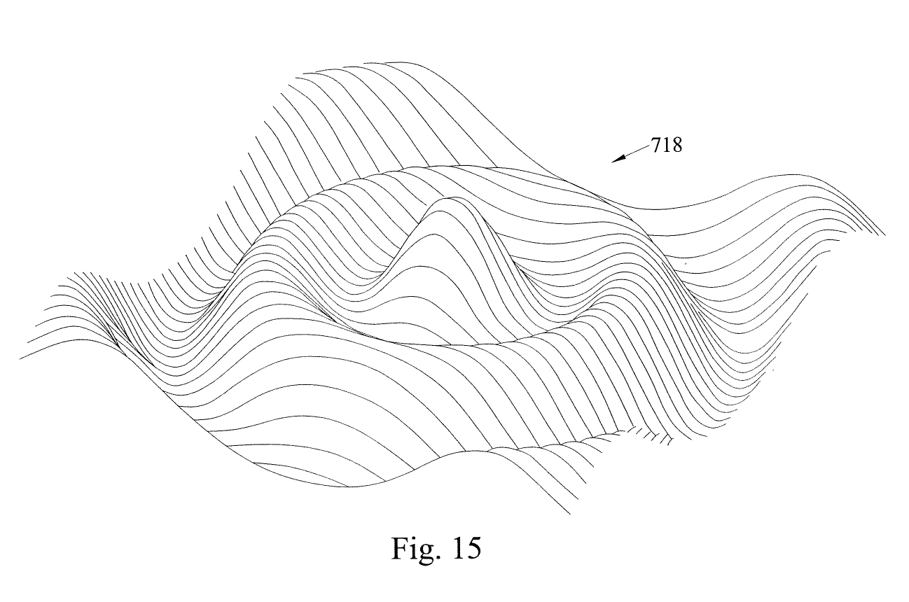

3: Plane Normal Determination Algorithm: This algorithm is applicable to a convex polyhedron without any concave lines such as a regular polyhedron or a crystal ball. The principle of this algorithm is to find the normal vector of each surface. If the Z-component of the normal vector is greater than 0 (or the surface faces the observer), then the surface is a visual plane 716. If the Z-component of the normal vector is smaller than 0, then the surface is a hidden surface 717, and no drawing is required (as shown in FIG. 14).

4: Surface Normal Determination Algorithm: A surface formula is used for determination basis. If it is used for calculating the light received by an object, then the coordinate of each point is introduced into the formula to obtain the normal vector for an inner product operation with the vector of the light in order to calculate the light received. In a drawing process, the farthest point is drawn first, so that the nearer point will block the farther point to handle the depth problem.

5: Maximum/Minimum Algorithm: The maximum Z-coordinate is drawn first, and then the Y-coordinate is used for determining whether to draw the largest point or the smallest point first, so as to form a 3D depth image 718 (as shown in FIG. 15).

The 3D image visual effect processing method of the present invention can highlight a visual effect by changing the depth coordinate position of a corresponding object when the cursor is operated and moved. In addition, the relative coordinate positions of other objects can be changed to further highlight the change of visual images.

While the invention has been described by means of specific embodiments, numerous modifications and variations could be made thereto by those skilled in the art without departing from the scope and spirit of the invention set forth in the claims.

What is claimed is:

1. A three-dimensional (3D) image visual effect processing method, comprising the steps of:
providing a 3D image, and the 3D image being comprised of a plurality of objects, and each of the objects having object coordinates;
providing a cursor, and the cursor having cursor coordinates;
determining whether or not the cursor coordinates are coincident with the object coordinates of one of the objects;
changing a depth coordinate parameter corresponding to the object coordinates of the plurality of object, when the cursor coordinates are coincident with the object coordinates of one of the objects; and
redrawing an image of the object matched with the cursor coordinates.

2. The 3D image visual effect processing method of claim 1, further comprising the step of determining whether or not the cursor coordinates are coincident with the object coordinates of one of the objects again, when the cursor coordinates are changed.

3. The 3D image visual effect processing method of claim 1, wherein the plurality of objects have coordinates corresponding to local coordinates, world coordinates, view coordinates or projection coordinates.

4. The 3D image visual effect processing method of claim 1, wherein the cursor coordinates are produced by a mouse, a touchpad or a touch panel.

5. The 3D image visual effect processing method of claim 1, wherein the 3D image is produced by a computer graphics procedure comprising a modeling, a layout & animation and a rendering sequentially.

6. The 3D image visual effect processing method of claim 1, wherein the depth coordinate parameter of the object coordinates of the plurality of objects is determined by a Z-buffer algorithm, a painter's algorithm (or depth-sort algorithm), a plane normal determination algorithm, a surface normal determination algorithm, or a maximum/minimum algorithm.
